(19) United States
(12) Patent Application Publication
(10) Pub. No.: US 2005/0196606 A1
(43) Pub. Date: Sep. 8, 2005

(54) Composite material, structure and polycrystalline structure film and method of making particles

(75) Inventors: Nobutaka Ihara, Kawasaki (JP); Takuya Uzumaki, Kawasaki (JP); Atsushi Tanaka, Kawasaki (JP); Satoru Momose, Kawasaki (JP); Hiroyoshi Kodama, Kawasaki (JP)

Correspondence Address: Patrick G. Burns, Esq.;GREER, BURNS & CRAIN, LTD., Suite 2500, 300 South Wacker Drive, Chicago, IL, 60606, US

(73) Assignee: FUJITSU LIMITED

(21) Appl. No.: 11/091,734

(22) Filed: Mar. 28, 2005

Related U.S. Application Data
(63) Continuation of application No. PCT/JP03/01875, filed on Feb. 20, 2003.

(51) Int. Cl. B32B 5/16

(52) U.S. Cl. 428/323

(57) ABSTRACT

A substrate defines minute holes or nanoholes over its surface in a composite material. Particles or nanoparticles are filled within the minute holes. The composite material enables a reliable disposition of the particles within the minute holes. The position of the minute holes can reliably be controlled. This serves to establish regularly ordered particles based on the regularly ordered minute holes. This composite material is applicable to a magnetic recording medium.

### BACKGROUND OF THE INVENTION

1. Field of the Invention

The present invention relates to a composite material, a structure and a polycrystalline structure film preferably applicable to a magnetic recording medium such as a hard disk (HD). The invention also relates to a method of making the composite material or the structure, and a method of making particles applicable to a magnetic recording medium, for example.

2. Description of the Prior Art

A minute hole such as a nanohole is well known in the technical field of a magnetic recording medium such as a hard disk, for example. The nanoholes are formed in an alumina (Al₂O₃) film extending over the surface of a substrate. The nanoholes are regularly arranged at minute distances. Magnetic material such as Co, a Co-based alloy, or the like, is filled in the individual nanoholes, for example. A magnetic crystalline grain is formed inside the individual nanoholes. The magnetic crystalline grain of the type serves to improve the recording density of the magnetic recording medium.

For example, vacuum evaporation, sputtering, electroplating, or the like, is employed to include the magnetic material in the nanoholes, as disclosed in Japanese Patent Application Publication Nos. 11-224422 and 2002-175621. These methods allow deposition of the excessive magnetic material over the surface of a magnetic recording layer. Grinding, etching, ion milling, or the like, should be effected to remove the deposited excessive magnetic material from the surface of the magnetic recording layer. Moreover, the magnetic material cannot sufficiently be included in the nanoholes if the nanoholes have a larger aspect ratio.

Utilization of FePt nanoparticles is proposed for a magnetic recording medium. Nanoparticles wrapped with oleic acid or oleylamine are prepared in a method of making the magnetic recording medium. The nanoparticles are kept in an organic solvent such as hexane, for example. The organic solvent containing the nanoparticles is applied to the surface of a substrate for the magnetic recording medium.

Annealing is then effected on the nanoparticles. The nanoparticles thus get crystallized. However, the annealing causes the nanoparticles to unite with each other based on a larger heat energy. This results in enlargement of the crystalline grains.

A magnetic polycrystalline layer is generally utilized for the magnetic recording layer. Reduction in the size of the crystalline grains in the magnetic polycrystalline layer leads to improvement in the recording density in the magnetic recording medium. A seed layer including minute crystalline cores, for example, is usually utilized to reduce the size of the crystalline grains. When a magnetic material is sputtered on the surface of the seed layer, minute crystalline grains are allowed to grow from the individual cores.

Sputtering is employed to form the seed layer. An ultra thin film of a metallic material is formed on a substrate based on sputtering, for example. The ultra thin film is then subjected to heat treatment. The minute crystalline cores are formed in the ultra thin film. However, the size and/or dispersion of the crystalline cores cannot sufficiently be controlled in the ultra thin film. The crystalline grains in the magnetic polycrystalline layer often suffer from variation in the size and the dispersion.

As disclosed in Japanese Patent Application Publication No. 2000-54012, a so-called polyol method may be utilized to make metallic nanoparticles. The polyol method is often used to generate cobalt particles, for example. The cobalt is reduced from a salt such as cobalt acetate with the assistance of a reducing agent such as ethyleneglycol, 1,2-diol, or the like. However, the polyol method tends to induce aggregation of nanoparticles. In particular, when the polyol method is employed to make nanoparticles of a metallic ally, enlargement of the nanoparticles cannot be avoided.

### SUMMARY OF THE INVENTION

It is accordingly an object of the present invention to provide a composite material contributing to a reliable and uniform filling of magnetic material within minute holes in a facilitated manner. It is an object of the invention to provide a method of making the same. It is another object of the present invention to provide a structure contributing to reduction in the size of crystalline grains. It is an object of the invention to provide a method of making the same. It is a further object of the invention to provide a polycrystalline structure film contributing to a reliable control on the size and dispersion of crystalline cores or seeds. It is a still further object of the invention to provide a method of making uniform particles in a facilitated manner.

According to a first aspect of the present invention, there is provided a composite material comprising: a substrate defining minute holes over its surface; and particles located within the minute holes.

The composite material enables a reliable disposition of the particles within the minute holes. Specifically, the minute holes are filled up with the particles. In addition, the position of the minute holes can reliably be controlled. This serves to establish regularly ordered particles based on the regularly ordered minute holes.

The composite material may further comprise a covering layer overlaid on the surface of the substrate so as to entrap the particles inside the minute holes. The covering layer serves to prevent the particles from getting out of the minute holes. This contributes to a reliable in existence of the particles over the surface of the substrate.

One of the substrate and the particles may be made of a magnetic material while the other of the substrate and the particles may be made of a non-magnetic material. Otherwise, one of the substrate and the particles may be made of an electrically conductive material while the other of the substrate and the particles may be made of an insulating material.

The particles may include atoms belonging to a metallic element in the composite material. The particles may be comprised of a polycrystalline grain or grains. The particles may allow establishment of the axis of easy magnetization aligned in the vertical direction perpendicular to the surface of the substrate. The diameter of the minute holes may be set in a range between 4 nm and 50 nm, for example. The depth of the minute holes may be set in accordance with the aspect ratio ranging from 2 to 10.

According to a second aspect of the present invention, there is provided a method of making a composite material, comprising: preparing a substrate defining minute holes over its surface; applying to the surface of the substrate liquid including a predetermined solvent containing particles; and wiping overspilling ones of the particles, said overspilling ones spilling out of the minute holes.

Since the liquid containing the particles dispersed in the solvent is simply applied to the surface of the substrate in the method of making the composite material, the particles are allowed to flow into the minute holes without any difficulty. The particles are thus uniformly filled in the minute holes. Here, spin coating or dipping may be effected to apply the liquid.

One of the substrate and the particles may be made of a magnetic material while the other of the substrate and the particles may be made of a non-magnetic material. The diameter of the minute holes may be set in a range between 4 nm and 50 nm, for example. The depth of the minute holes may be set in accordance with the aspect ratio ranging from 2 to 10.

It should be noted that the aforementioned composite material may be utilized in a perpendicular magnetic recording medium such as a hard disk (HD) and other types of a magnetic recording medium drive.

According to a third aspect of the present invention, there is provided a structure comprising: an aggregation of particles; and carbon atoms existing between the particles, wherein the atomicity of the carbon atoms is set in a range between 45 atom % and 96 atom % to the sum of the atomicity of the carbon atoms and the atomicity of atoms forming the particles.

The diameter of the particles may be set in a range between 1 nm and 30 nm, for example. The particles maybe made of a magnetic material such as any one or more of Fe, Co and Ni. The particles may include a crystalline grain or grains.

According to a fourth aspect of the present invention, there is provided a method of making a structure, comprising: applying to the surface of an object an organic solvent containing metallic particles wrapped with an organic compound; and annealing the metallic particles under a vacuum atmosphere after evaporation of the organic solvent, wherein the atomicity of the carbon atoms included in the organic compound is set in a range between 45 atom % and 96 atom % to the sum of the atomicity of the carbon atoms and the atomicity of atoms forming the metallic particles.

The organic compound of a relatively larger amount serves to prevent the metallic particles from accretion irrespective of the annealing in the method. The metallic particles are maintained as fine crystalline grains.

The method may further comprise subjecting the organic compound to heating treatment under atmosphere of inert gas prior to annealing. A flat surface can reliably be established on the surface of a layer comprised of the metallic particles and the organic compound irrespective of the organic compound of an increased amount.

According to a fifth aspect of the present invention, there is provided a polycrystalline structure film comprising: a substratum; particles located on a surface of the substratum; and a crystalline layer including crystalline grains growing from the particles.

The crystalline grains are allowed to grow from the particles in the polycrystalline structure film. Since the size and dispersion of the particles can reliably be controlled, the size and distribution of the crystalline grains can reliably be controlled in the crystalline layer.

The particles may contain atoms belonging to a metallic element. The diameter of the particles may be set in a range between 1 nm and 30 nm, for example. The particles may form a continuous layer extending on the surface of the substratum.

The polycrystalline structure film may be employed in a magnetic recording medium. The magnetic recording medium may include a basement polycrystalline layer including first crystalline grains growing from particles; and a magnetic polycrystalline layer including second crystalline grains growing from the individual ones of the first polycrystalline grains of the basement polycrystalline layer.

Likewise, the polycrystalline structure film may be employed in a so-called perpendicular magnetic recording medium. Here, the magnetic recording medium may further include a soft magnetic underlayer located underneath the magnetic polycrystalline layer; and a non-magnetic layer located between the soft magnetic underlayer and the magnetic polycrystalline layer so as to isolate the magnetic polycrystalline layer from the soft magnetic underlayer.

The magnetic recording medium allows growth of the crystalline grains in the basement polycrystalline layer based on the particles. Since the size and dispersion of the particles can sufficiently be controlled, the size and distribution of the crystalline grains can reliably be controlled in the basement polycrystalline layer. The crystalline grains in the magnetic polycrystalline layer grow from the individual crystalline grains in the basement polycrystalline layer, so that the size and distribution of the crystalline grains can in turn reliably be controlled in the magnetic polycrystalline layer. This contribute to improvement in the recording density.

The particles may include atoms belonging to a metallic element in the same manner as described above. In addition, the diameter of the particles may be set in a range between 1 nm and 30 nm, for example.

According to a sixth aspect of the present invention, there is provided a method of making particles, comprising: preparing a solution including an organic solvent containing a reducing agent refractory to the organic solvent, a metallic compound and an organic stabilizer; and stirring the solution at a predetermined reaction temperature.

The method enables isolation of the reducing agent and the organic solvent from each other since the reducing agent is refractory to the organic solvent. The polarity of the solution can be kept lower, so that the particles are reliably prevented from accretion. The fine and uniform particles can thus be obtained in a facilitated manner.

The metallic compound may be selected from a group consisting of acetylacetonate salt, a salt of organic acid having the carbon number ranging from 1 to 20, bromide and iodide. Two or more kinds of the metallic compound may be employed in forming the particles.

The organic solvent may be an aprotic organic solvent having a carbon number in a range between 6 and 20. The organic solvent may be selected from a group consisting of hydrocarbon, ether and ester. The reducing agent may be 1,2-diol having a carbon number in a range between 2 and 6.

The organic stabilizer may include carboxylic acid, R-COOH, for example. In this case, “R” may be selected from a group consisting of C₁₂H₂₃, C₁₇H₃₃ and C₂₁H₄₁. Otherwise, the organic stabilizer may include amine, R-NH₂, for example. “R” may likewise be selected from a group consisting of C₁₃H₂₅, C₁₆H₃₅ and C₂₂H₄₃.

The reaction temperature may be set in a range between 100 degrees Celsius and 300 degrees Celsius.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive (HDD) as a specific example of a magnetic recording medium drive;

FIG. 2 is an enlarged partial sectional view of a magnetic recording disk according to a first embodiment of the present invention;

FIG. 3 is an enlarged partial sectional view of a substrate for the magnetic recording disk for schematically illustrating the process of forming minute depressions on the surface of an aluminum film;

FIG. 4 is an enlarged partial sectional view of the substrate for schematically illustrating the process of forming nanoholes on the surface of a matrix layer;

FIG. 5 is an enlarged partial sectional view of the substrate for schematically illustrating the process of applying to the surface of the matrix layer liquid containing nanoparticles;

FIG. 6 is an enlarged partial sectional view of the substrate for schematically illustrating the process of wiping the nanoparticles remaining on the surface of the matrix layer;

FIG. 7 is an enlarged partial sectional view of a magnetic recording disk according to a second embodiment of the present invention;

FIG. 8 is an enlarged partial sectional view of a substrate for the magnetic recording disk for schematically illustrating the process of subjecting a liquid layer to heat treatment;

FIG. 9 is an enlarged partial sectional view of the substrate for schematically illustrating the liquid layer after the heat treatment;

FIG. 10 is an image from AFM, atomic force microscope, of an example of the magnetic recording disk;

FIG. 11 is an image from AFM of a comparative example of the magnetic recording disk;

FIG. 12 is an enlarged partial sectional view of a magnetic recording disk according to a third embodiment of the present invention;

FIG. 13 is an enlarged partial sectional view of a magnetic recording disk according to a modification of the third embodiment;

FIG. 14 is a side view schematically illustrating the structure of a spin coater; and

FIG. 15 is a table showing the relationship between the amount of metallic compounds and the composition of nanoparticles.

### DESCRIPTION OF THE PREFERRED EMBODIMENTS

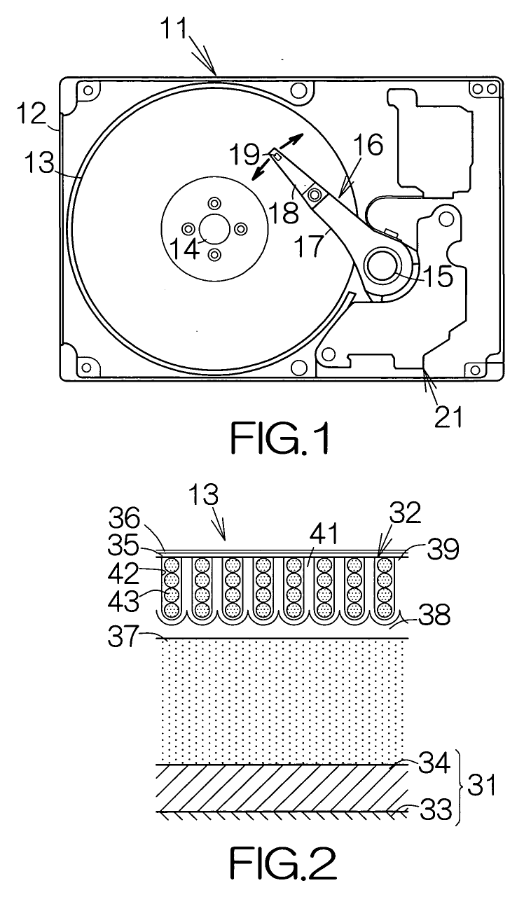

FIG. 1 schematically illustrates the interior structure of a hard disk drive (HDD) 11 as an example of a magnetic recording medium drive or storage device. The HDD 11 includes a box-shaped main enclosure 12 defining an inner space of a flat parallelepiped, for example. At least one magnetic recording disk 13 is incorporated in the inner space within the main enclosure 12. The magnetic recording disk or disks 13 is mounted on the driving shaft of a spindle motor 14. The spindle motor 14 is allowed to drive the magnetic recording disk or disks 13 for rotation at a higher revolution rate such as 7,200 rpm, 10,000 rpm, or the like, for example. A cover, not shown, is coupled to the main enclosure 12 so as to define the closed inner space between the main enclosure 12 and itself.

A head actuator 16 is coupled to a vertical support shaft 15. The head actuator 16 includes rigid actuator arms 17 extending in the horizontal direction from the vertical support shaft 15, and head suspensions 18 respectively attached to the tip ends of the actuator arms 17 so as to extend in the forward direction from the corresponding actuator arms 17. As conventionally known, a flying head slider 19 is cantilevered at the tip end of the elastic suspension 18 through a gimbal, not shown. The elastic suspension 18 serves to urge the flying head slider 19 toward the surface of the magnetic recording disk 13. When the magnetic recording disk 13 rotates, the flying head slider 19 receives airflow generated along the surface of the rotating magnetic recording disk 13. The airflow serves to generate a lift on the flying head slider 19. The flying head slider 19 is thus allowed to keep flying above the surface of the magnetic recording disk 13 during the rotation of the magnetic recording disk 13 at a higher stability established by the balance between the lift and the urging force of the elastic suspension 18.

An electromagnetic transducer, not shown, is mounted on the flying head slider 19 in a conventional manner. The electromagnetic transducer includes a read element such as a giant magnetoresistive (GMR) element or tunnel junction magnetoresistive (TMR) element and a write element such as a single pole head or inductive thin film head, for example. The GMR element or TMR element is designed to detect a magnetic bit data by utilizing variation of the electric resistance in a spin valve film or tunnel junction film in response to the inversion of the magnetic polarity in a magnetic field acting from the magnetic recording disk 13. The single pole head or inductive thin film head is designed to write a magnetic bit data onto the magnetic recording disk 13 by utilizing a magnetic field induced in a conductive swirly coil pattern, not shown, for example.

When the head actuator 16 is driven to swing about the support shaft 15 during the flight of the flying head slider 19, the flying head slider 19 is allowed to cross the recording tracks defined on the magnetic recording disk 13 in the radial direction of the magnetic recording disk 13. This radial movement serves to position the electromagnetic transducer on the flying head slider 19 right above a target recording track on the magnetic recording disk 13. A power source 21 such as a voice coil motor (VCM) may be utilized to realize the rotation of the head actuator 16 around the support shaft 15. As conventionally known, in the case where two or more magnetic recording disks 13 are incorporated within the inner space of the main enclosure 12, a pair of the actuator arm 17, 17 and a pair of the flying head slider 19, 19 are disposed between the adjacent magnetic recording disks 13.

FIG. 2 illustrates a vertical sectional view of the magnetic recording disk 13 according to a first embodiment of the present invention. The magnetic recording disk 13 belongs to a so-called perpendicular magnetic recording medium. The magnetic recording disk 13 includes a substrate 31 as a support member and a multilayered structure film 32 extending on the front and back surfaces of the substrate 31. The substrate 31 may comprise a disk-shaped Si body 33 and amorphous SiO₂ films 34 extending on the front and back surfaces of the Si body 33. Alternatively, a glass substrate, an aluminum substrate, a ceramic substrate, or the like, may be employed as the substrate 31. Magnetic information is recorded in the multilayered structure film 32. A protection overcoat 35 such as a diamond-like-carbon (DLC) film and a lubricating agent film 36 such as a perfluoropolyether (PFPE) film may be formed to cover over the surface of the multilayered structure film 32.

The multilayered structure film 32 includes soft magnetic underlayers 37 extending on the front and back surfaces of the substrate 31, respectively. The underlayer 37 may be made of a soft magnetic material such as FeTaC, NiFe, or the like. Here, a FeTaC film having the thickness of 200 nm approximately is employed as the underlayer 37. The underlayer 37 allows establishment of the axis of easy magnetization within a plane parallel to the surface of the substrate 31.

An intermediate layer 38 extends on the surface of the underlayer 37. The intermediate layer 38 may be made of a non-magnetic material such as aluminum. A composite material or magnetic recording layer 39 extends on the surface of the intermediate layer 38. The magnetic recording layer 39 includes a matrix layer 41 extending on the surface of the intermediate layer 38. The matrix layer 41 may be made of a non-magnetic material such as alumina (Al₂O₃).

Minute holes or nanoholes 42 are formed on the surface of the matrix layer 41. The nanoholes 42 are regularly ordered on the surface of the matrix layer 41. The nanoholes 42 may be located on concentric circles spaced at equal distances over the surface of the magnetic recording disk 13, for example. The nanoholes 42 are spaced in the individual concentric circles by a distance equal to that between the adjacent concentric circles. The space between the adjacent nanoholes 42 may be set in a range between 4 nm and 30 nm approximately, for example. The diameter of the nanoholes 42 may be set in a range between 4 nm and 50 nm, for example. The depth of the nanoholes 42 may be set based on the aspect ratio in a range between 2 and 10. The aspect ratio represents a ratio of the depth to the diameter of the nanoholes 42.

Minute particles or nanoparticles 43 are disposed in the nanoholes 42. The nanoparticles 43 contain atoms belonging to a metallic element. The nanoparticles 43 may contain a magnetic material such as one or more of Fe, Co and Ni, for example. The nanoparticles 43 may further contain Cr, Pt and Pd, for example. Here, FePt alloy is employed as the nanoparticles 43.

The nanoparticle 43 is formed as a crystalline grain or grains. The individual crystalline grains allow establishment of the axis of easy magnetization in the vertical direction perpendicular to the surface of the matrix layer 41. The crystalline grain is wrapped with carbon atoms. The carbon atoms serves to isolate the crystalline grains from each other. Alternatively, the crystalline grains may be subjected to accretion within the individual nanoholes 42. In this case, the aggregation of the crystalline grains may be wrapped with carbon atoms.

The diameter of the nanoparticles 43 is set smaller than that of the nanoholes 42. The diameter of the nanoparticles 43 may be set in a range between two fifth the diameter of the nanoholes 42 and half the diameter of the nanoholes 42. The diameter dispersion σ/D may be set equal to or smaller than 10%. Here, the diameter dispersion is referred to as the ratio of the standard deviation σ for the distribution of the diameter relative to the average diameter D of the nanoparticles 43. The space between the adjacent nanoparticles 43 may be set in a range between 0.2 nm and 5.0 nm approximately within the nanoholes 42.

As is apparent from FIG. 2, the protection overcoat 35 is formed on the surface of the matrix layer 41. The protection overcoat 35 serves to entrap the nanoparticles 43 within the nanoholes 42. Specifically, the protection overcoat 35 serves as a covering layer of the invention. The protection overcoat 35 allows a complete inclusion of the nanoparticles 43 within the nanoholes 42. The nanoparticles 43 exists within the nanoholes 42 but on the surface of the matrix layer 41.

The direction of the magnetization in the magnetic recording layer 39 can be determined based on the nanoparticles 43 in the magnetic recording disk 13. The nanoholes 42 serve to regularly order the nanoparticles 43. The regularly ordered nanoparticles 43 serve to establish a clear contour for the individual magnetized area. A so-called transition noise can thus reliably be suppressed. The magnetic recording disk 13 of the type reliably contributes to improvement in the recording density.

Next, a detailed description will be made on a method of making the magnetic recording disk 13. The disk-shaped substrate 31 is first prepared. The soft magnetic underlayer 37 and an aluminum layer are sequentially formed on the surface of the substrate 31. Sputtering or vacuum evaporation may be employed to form the underlayer 37 and the aluminum film, for example. The nanoholes 42 are then formed in the aluminum film. The aluminum film gets oxidized from the surface in the process of forming the nanoholes 42. The aluminum film in this manner provides the intermediate layer 38 and the matrix layer 41. A method of forming the nanoholes 42 will be described later in detail.

The nanoparticles 43 are subsequently filled within the individual nanoholes 42. The nanoparticles 43 are then subjected to heat treatment. The substrate 31 is placed in an annealing chamber. The vacuum atmosphere equal to or smaller than 3×10⁻⁵[Pa] is established in the annealing chamber. The temperature is set in a range between 200 degrees Celsius and 900 degrees Celsius within the annealing chamber. The temperature of 800 degrees Celsius may be kept for 30 minutes. The temperature rises to 800 degrees Celsius from the room temperature in ten minutes in the annealing chamber. A magnetic field is applied to the nanoparticles 43 during the heat treatment. The magnitude of the magnetic field may be set in a range between 0.1[T] and 10.0[T], for example. This serves to establish the axis of easy magnetization in a predetermined direction within the individual nanoparticles 43. The substrate 31 is subsequently cooled down to the room temperature.

When the nanoholes 42 have been filled up with the nanoparticles 43, the protection overcoat 35 and the lubricating agent film 36 are formed on the surface of the matrix layer 41. Sputtering may be employed to form the protection overcoat 35, for example. Dipping method may be employed to apply the lubricating agent film 36 on the magnetic recording disk 13, for example.

Next, a detailed description will be made on a method of forming the nanoholes 43. As shown in FIG. 3, a die 45 is pressed onto the surface of the aluminum film 44 on the substrate 31. Tiny protrusions 46 are previously formed on the surface of the die 45 at predetermined intervals. The tiny protrusions 46 serve to form minute depressions 47 on the aluminum film 44.

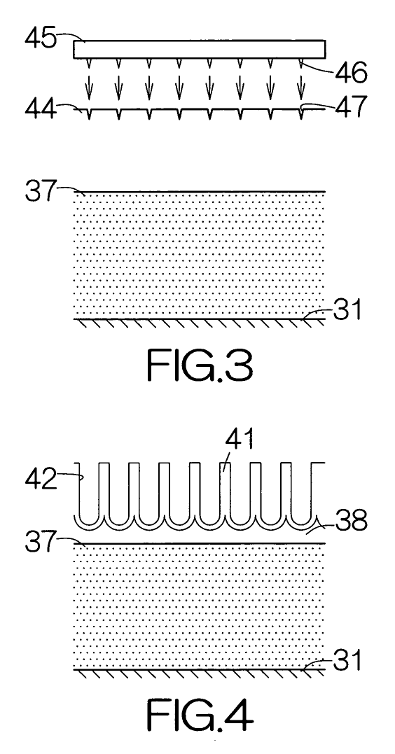

The aluminum film 44 is then subjected to anodization. The aluminum film 44 is dipped into an aqueous solution. The aqueous solution containing oxalic acid of 0.5[M] at 25 degrees Celsius is used as the solution, for example. The voltage of 40[V] is applied, for example. The anodization causes the aluminum film 44 to get oxidized from the surface. The nanoholes 42 grow from the depressions 47. As shown in FIG. 4, the nanoholes 42 can in this manner be obtained in the surface of the matrix layer 41. The matrix layer 41 is thereafter dipped into a phosphoric acid solution. The inner surface of the nanohole 42 is thus subjected to etching in response to reaction with the phosphoric acid. The diameter of the nanoholes 42 is in this manner increased to 10 nm approximately, for example. The depth of the nanoholes 42 is simultaneously set at 30 nm approximately. The aluminum film 44 left out of the reaction of anodization remains as the intermediate layer 38.

Next, a brief description will be made on a method of filling the nanoparticles 43 within the nanoholes 42. A conventional superhydride method or polyol method may be employed to form the nanoparticles 43. The diameter of the nanoparticles 43 is set at 7 nm approximately, for example. The individual nanoparticles 43 are wrapped with an organic compound or an organic stabilizer. The organic stabilizer may include a carboxylic acid, R-COOH, or an amine, R-NH₂, for example. In this case, “R” may be a straight chain or branched alkyl or alkenyl hydrocarbon. The nanoparticles 43 wrapped with the organic stabilizer are then added into a predetermined organic solvent. The nanoparticles 43 disperse in the organic solvent. An organic solvent such as hexane, heptane, octane, or the like, may be employed as the organic solvent.

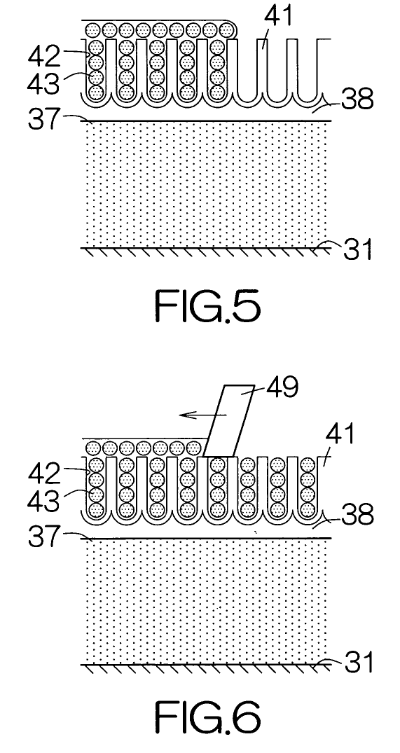

As shown in FIG. 5, the nanoparticles 43 are then filled within the aforementioned nanoholes 42 in the matrix layer 41, for example. The liquid containing the nanoparticles 43 wrapped with the organic stabilizer is applied to the surface of the matrix layer 41. Spin coating or dipping may be utilized to apply the liquid to the surface of the matrix layer 41.

As shown in FIG. 6, the nanoparticles 43 overspilling out of the nanoholes 42 are thereafter wiped out from the surface of the matrix layer 41. A wiper 49 is pressed against the surface of the matrix layer 41 during rotation of the substrate 31 so as to remove the nanoparticles 43 from the surface of the matrix layer 41. The wiper 49 may include an elastic member such as a rubber member for contacting with the matrix layer 41. The wiper 49 serves to completely wipe out the nanoparticles 43 existing on the surface of the matrix layer 41. The nanoholes 42 are thus completely filled with the nanoparticles 43.

Since the liquid containing the nanoparticles 43 dispersed in the solvent is simply applied to the surface of the matrix layer 41 in the method of making the magnetic recording disk 13 as described above, the nanoparticles 43 are allowed to flow into the nanoholes 42 without any difficulty. In addition, the nanoparticles 43 overspilling out of the nanohole 42 are clearly wiped out from the surface of the matrix layer 41. The magnetic nanoparticles 43 thus remain only within the nanoholes 42.

The magnetic recording layer 39 may include the matrix layer 41 made of a non-magnetic material and the nanoparticles 43 made of a magnetic material in the aforementioned manner. Alternatively, the matrix layer 41 may be made of a magnetic layer while the nanoparticles may be made of a non-magnetic material, for example. Otherwise, one of the matrix layer 41 and the nanoparticles 43 may be made of an electrically conductive material while the other of the matrix layer 41 and the nanoparticles 43 may be made of an insulating material.

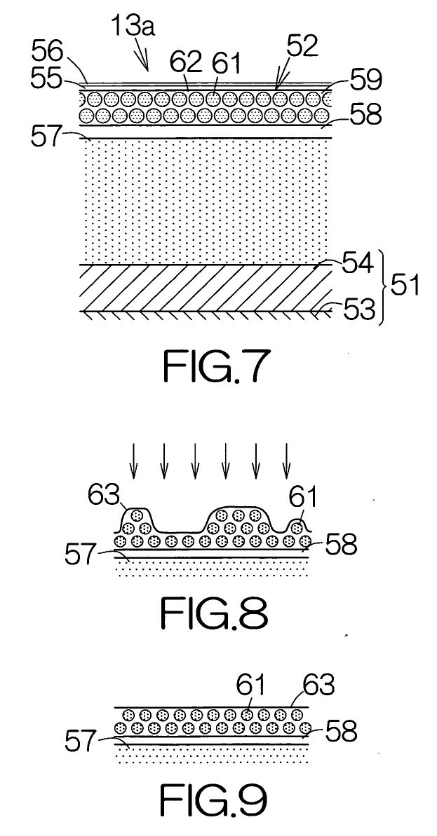

FIG. 7 illustrates the vertical sectional view of a magnetic recording disk 13a according to a second embodiment of the present invention. The magnetic recording disk 13a belongs to a so-called perpendicular magnetic recording medium. The magnetic recording disk 13a includes a substrate 51 as a support member and multilayered structure films 52 extending on the front and back surfaces of the substrate 51. The substrate 51 may comprise a disk-shaped Si body 53 and amorphous SiO₂ films 54 extending on the front and back surfaces of the Si body 53. Alternatively, a glass substrate, an aluminum substrate, a ceramic substrate, or the like, may be employed as the substrate 51. Magnetic information is recorded in the multilayered structure films 52. A protection overcoat 55 such as a diamond-like-carbon (DLC) film and a lubricating agent film 56 such as a perfluoropolyether (PFPE) film may be formed to cover over the surface of the multilayered structure film 52.

The multilayered structure film 52 includes soft magnetic underlayers 57 extending on the front and back surfaces of the substrate 51, respectively. The underlayer 57 may be made of a soft magnetic material such as FeTaC, NiFe, or the like. Here, a FeTaC film having the thickness of 200 nm approximately is employed as the underlayer 57. The underlayer 57 allows establishment of the axis of easy magnetization within a plane parallel to the surface of the substrate 51.

An intermediate layer 58 extends on the surface of the underlayer 57. The intermediate layer 58 may be made of a non-magnetic material such as a carbon film. Here, a carbon film having the thickness of 5 nm approximately is employed as the intermediate layer 58.

A structure or magnetic recording layer 59 extends on the surface of the intermediate layer 58. The thickness of the magnetic recording layer 59 may be set at 30 nm approximately, for example. The magnetic recording layer 59 includes an aggregation of minute particles or metallic nanoparticles 61 extending on the surface of the intermediate layer 58. The metallic nanoparticles 61 may contain a magnetic material such as one or more of Fe, Co and Ni, for example. The metallic nanoparticles 61 may further contain Pt and/or Pd, for example. Here, FePt alloy is employed as the metallic nanoparticles 61. The metallic nanoparticle 61 is formed as a crystalline grain or grains. The individual crystalline grains allow establishment of the axis of easy magnetization in the vertical direction perpendicular to the surface of the substrate 51.

The diameter of the nanoparticles 61 may be set in a range between 2 nm and 10 nm, for example. The space between the adjacent metallic nanoparticles 61 may be set in a range between 0.2 nm and 5.0 nm approximately. The diameter dispersion σ/D may be set equal to or smaller than 10% for the metallic nanoparticles 61.

Carbon atoms 62 exist between the metallic nanoparticles 61 in the magnetic recording layer 59. The carbon atoms 62 serve to couple the metallic nanoparticles 61 with each other. The atomicity of the carbon atoms 62 is set in a range between 45 atom % and 96 atom % to the sum of the atomicity of the carbon atoms 62 and the atomicity of atoms forming the metallic nanoparticles 61 in the magnetic recording layer 59.

Next, a detailed description will be made on a method of making the magnetic recording disk 13a. The disk-shaped substrate 51 is first prepared. The soft magnetic underlayer 57 and the intermediate layer 58 are sequentially formed on the surface of the substrate 51. Sputtering or vacuum evaporation may be employed to form the underlayer 57 and the intermediate layer 58, for example. The aggregation of the metallic nanoparticles 61 is subsequently formed on the surface of the intermediate layer 58. Processes for forming the aggregation will be described later in detail. The protection overcoat 55 and the lubricating agent film 56 are then formed on the surface of the aggregation of the metallic nanoparticles 61. Sputtering may be employed to form the protection overcoat 55, for example. Dipping method may be employed to apply the lubricating agent film 56 on the magnetic recording disk 13a, for example.

Liquid including an organic solvent such as hexane containing the metallic nanoparticles 61 is prepared to form the aggregation of the metallic nanoparticles 61. The metallic nanoparticles 61 may be made of FePt alloy, for example. The diameter of the metallic nanoparticles 61 is set at 7 nm approximately, for example. The individual metallic nanoparticles 61 are wrapped with an organic compound or organic stabilizer. The organic stabilizer may include a carboxylic acid, R-COOH, or an amine, R-NH₂, for example. In this case, “R” may be a straight chain or branched alkyl or alkenyl hydrocarbon. The atomicity of the carbon atoms in the organic stabilizer is set in a range between 45 atom % and 96 atom % to the sum of the atomicity of the carbon atoms in the organic stabilizer and the atomicity of atoms forming the metallic nanoparticles 61.

The organic solvent containing the metallic nanoparticles 61 and the organic stabilizer is applied to the surface of the intermediate layer 58. Spin coating or dipping may be employed to apply the organic solvent to the intermediate layer 58. The organic solvent then evaporates. The metallic nanoparticles 61 and the organic stabilizer remain on the surface of the intermediate layer 58. Since the organic stabilizer is contained in the organic solvent at a relatively larger amount in the aforementioned manner, the metallic nanoparticles 16 suffer from uneven distribution on the surface of the intermediate layer 58, as shown in FIG. 8. Inequality is established on the surface of a liquid layer 63 comprised of the nanoparticles 61 and the organic stabilizer.

Heat treatment is then effected on the surface of the intermediate layer 58. The organic stabilizer is subjected to heat ranging from 100 degrees Celsius to 300 degrees Celsius under the atmosphere of inert gas such as nitrogen. The heat treatment is kept for a duration between one minute and sixty minutes, for example. As shown in FIG. 9, the distribution of the metallic nanoparticles 61 is in this manner leveled on the surface of the intermediate layer 58. A flat surface can be established on the surface of the liquid layer 63 comprised of the metallic nanoparticles 61 and the organic stabilizer.

The metallic nanoparticles 61 are then subjected to annealing under a vacuum atmosphere. The substrate 51 is placed in an annealing chamber. The vacuum atmosphere equal to or smaller than 3×10⁵[Pa] is established in the annealing chamber. The temperature is set in a range between 200 degrees Celsius and 900 degrees Celsius within the annealing chamber. The temperature of 800 degrees Celsius may be kept for 30 minutes. The temperature rises to 800 degrees Celsius from the room temperature in ten minutes in the annealing chamber. A magnetic field is applied to the metallic nanoparticles 61 during the heat treatment. The magnitude of the magnetic field may be set in a range between 0.1[T] and 10.0[T], for example. The heat serves to crystallize the individual metallic nanoparticles 61. The applied magnetic field during the heat treatment serves to establish the axis of easy magnetization in a predetermined direction within the individual metallic nanoparticles 61. The substrate 51 is subsequently cooled down to the room temperature.

The organic stabilizer of a relatively larger amount serves to prevent the metallic nanoparticles 61 from accretion irrespective of the annealing in the method of making the magnetic recording disk 13a. The metallic nanoparticles 61 are maintained as fine crystalline grains. The magnetic domain can thus be minimized. The minimized magnetic domain contributes to improvement in the recording density of the magnetic recording disk 13a.

In addition, a heat treatment is effected prior to the annealing. A flat surface can reliably be established on the surface of the liquid layer 63 comprised of the metallic nanoparticles 61 and the organic stabilizer irrespective of the organic stabilizer of an increased amount. The unevenness is greatly suppressed on the surface of the magnetic recording disk 13a. The hard disk drive 11 allows the flying head slider 19 to stably keep flying at a fixed attitude.

The inventors have observed the aggregation of the metallic nanoparticles based on images from FE-SEM, Field Emission Scanning Electron Microscope. The inventors prepared a first example of the invention and a first comparative example for the observation. The organic stabilizer of an amount larger than a conventional amount is disposed around the metallic nanoparticles 61 according to the first example. The organic stabilizer of a smaller amount equal to the conventional amount is disposed around the metallic nanoparticles 61 according to the first comparative example. Here, “smaller amount” means the maximum molecular number capable of surrounding a single one of the metallic nanoparticles 61. Accordingly, the first example of the invention is supposed to allow not only attachment of the organic stabilizer to the individual metallic nanoparticles 61 but also movement of the organic stabilizer in a space between the metallic nanoparticles 61. The metallic nanoparticles 61 in the first example and the first comparative example were subjected to the aforementioned annealing. The inventors have observed retention of fine metallic nanoparticles 61 or fine crystalline grains in the first example of the invention. A larger unevenness was observed on the surface of the aggregation of the metallic nanoparticles 61. On the other hand, the surface of the aggregation of the metallic nanoparticles 61 was kept even in the first comparative example. However, the metallic nanoparticles 61 united with each other, resulting in enlargement of the crystalline grains.

The inventors have also observed the surface of the liquid layer 63 when the metallic nanoparticles 61 and the organic stabilizer had been applied. Unevenness was observed on the surface of the liquid layer 63 in the first example. A flat surface was observed on the surface of the liquid layer 63 in the first comparative example.

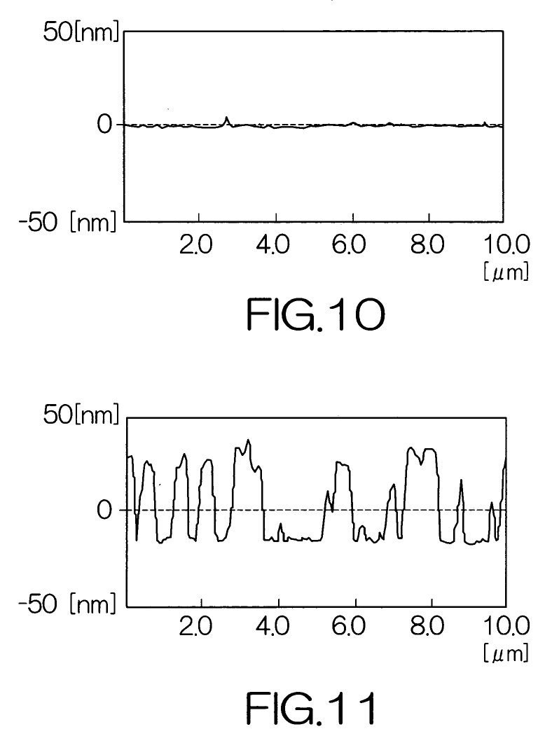

Furthermore, the inventors have observed the aggregation of the metallic nanoparticles 61 based on images from AFM, Atomic Force Microscope. The inventors prepared a second example of the invention and a second comparative example for the observation. The organic stabilizer of an amount larger than a conventional amount was disposed around the metallic nanoparticles 61 in the second example and the second comparative example in the same manner as the aforementioned first example of the invention. The metallic nanoparticles 61 were subjected to annealing in the second example and the second comparative example. The aforementioned heat treatment was effected on the metallic nanoparticles 61 prior to the annealing in the second example of the invention. The metallic nanoparticles 61 and the organic stabilizer were subjected to heat of 200 degrees Celsius under the atmosphere of nitrogen for five minutes. On the other hand, the aforementioned heat treatment was omitted prior to the annealing in the second comparative example. As shown in FIG. 10, a flat surface can be obtained on the surface of the aggregation of the metallic nanoparticles 61 in the second example of the invention. The surface roughness Ra of 44 pm was obtained in an area of 1 μm square. As is apparent from FIG. 11, unevenness was observed on the surface of the aggregation of the metallic nanoparticles 61 in the second comparative example. The surface roughness Ra of 909 pm was obtained in an area of 1 μm square.

Furthermore, the inventors have observed the aggregation of the metallic nanoparticles 61 based on images from FE-SEM in the same manner as described above. Three kinds of examples were prepared. The organic stabilizer of an amount larger than a conventional amount is disposed around the metallic nanoparticles 61 in any of the examples in the same manner as the aforementioned first example of the invention. The metallic nanoparticles 61 were subjected to annealing in any of the examples. The aforementioned heat treatment was also effected on the metallic nanoparticles 61 prior to the annealing in any of the examples. The duration of the heat treatment was selectively set at five minutes, thirty minutes and forty five minutes, for the examples. The heat treatment for five minutes and thirty minutes enabled retention of fine metallic nanoparticles 61. A flat surface was obtained over the surface of the aggregation of the metallic nanoparticles 61. The heat treatment for forty five minutes has induced accretion of the metallic nanoparticles 61. Fine metallic nanoparticles 61 could not be kept.

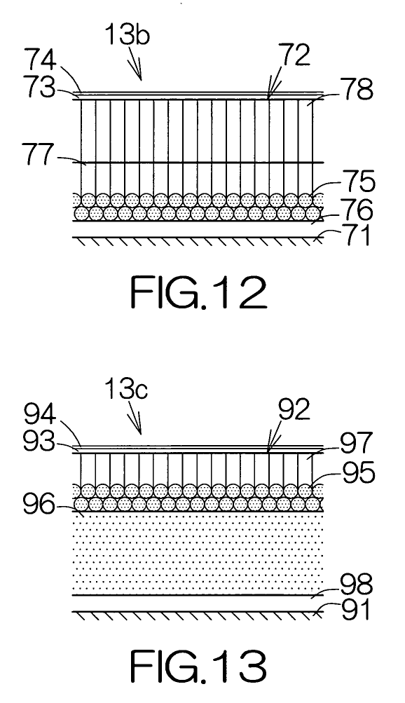

FIG. 12 illustrates a vertical sectional view of the magnetic recording disk 13b according to a third embodiment of the present invention. The magnetic recording disk 13b belongs to a so-called perpendicular magnetic recording medium. The magnetic recording disk 13b includes a substrate 71 as a support member and polycrystalline structure films 72 extending on the front and back surfaces of the substrate 71. A glass substrate may be employed as the substrate 71, for example. Alternatively, an aluminum substrate, a silicon substrate, a ceramic substrate, or the like, may be employed as the substrate 71. Magnetic information is recorded in the polycrystalline structure films 72. A protection overcoat 73 such as a diamond-like-carbon (DLC) film and a lubricating agent film 74 such as a perfluoropolyether (PFPE) film may be formed to cover over the surface of the polycrystalline structure film 72.

The polycrystalline structure film 72 includes minute particles or nanoparticles 75 existing on the surface of the substrate 71 serving as a substratum. The nanoparticles 75 forms a continuous film extending on the surface of the substrate 71 without a gap. The thickness of the continuous film may be set at 20 nm approximately, for example. The nanoparticles 75 contain atoms belonging to a metallic element. Fe and Pt may be included in the metallic element, for example. Here, FePt alloy is employed in the nanoparticles 75. The diameter of the nanoparticles 75 may be set in a range between 2 nm and 10 nm, for example. The diameter dispersion σ/D may be set equal to or smaller than 20% for the nanoparticles 75.

As is apparent from FIG. 12, an adhesion layer 76 may be interposed between the substrate 71 and the nanoparticles 75. A carbon film may be employed as the adhesion layer 76, for example. The adhesion layer 76 serves to improve adhesion between the substrate 71 and the nanoparticles 75.

A basement polycrystalline layer 77 extends on the surface of the nanoparticles 75. The basement polycrystalline layer 77 includes crystalline grains growing from the nanoparticles 75. The basement polycrystalline layer 77 may be made of an alloy containing Pt and Pd, for example. Here, a PtPd film having the thickness of 5 nm approximately is employed as the basement polycrystalline layer 77.

A magnetic polycrystalline layer 78 extends on the surface of the basement polycrystalline layer 77. The magnetic polycrystalline layer 78 includes crystalline grains growing from the individual crystalline grains of the basement polycrystalline layer 77 based on the epitaxy. Magnetic information is recorded in the magnetic polycrystalline film 77. The magnetic polycrystalline layer 78 may be made of an alloy including at least any one of the Co, Ni and Fe, for example. Here, a CoCrPt film having the thickness equal to 15 nm approximately is employed as the magnetic polycrystalline layer 78.

The polycrystalline structure film 72 allows the crystalline grains in the basement polycrystalline layer 77 to grow from the nanoparticles 75. Since the size and dispersion of the nanoparticles 75 can sufficiently be controlled, the size and distribution of the crystalline grains can reliably be controlled in the basement polycrystalline layer 77. The individual crystalline grains in the magnetic polycrystalline layer 78 grow from the individual crystalline grains in the basement polycrystalline layer 77, so that the size and the dispersion of the polycrystalline grains can reliably be controlled based on the size and dispersion of the nanoparticles 75. The magnetic recording disk 13b is allowed to enjoy improvement in the recording density.

Next, a detailed description will be made on a method of making the magnetic recording disk 13b. The disk-shaped substrate 71 is first prepared. The adhesion layer 76 made of carbon is formed on the surface of the substrate 71. Vacuum evaporation is employed to form the adhesion layer 76, for example. The thickness of the adhesion layer 76 may be set at 4 nm approximately, for example.

The nanoparticles 75 are applied to the surface of the adhesion layer 76 based on spin coating. The substrate 71 is driven for rotation at the rotation speed of 300 rpm in the spin coating. The substrate 71 is then placed in the atmosphere of hexane, for example. The rotation speed of the substrate 71 is subsequently reduced to 60 rpm. Liquid including an organic solvent containing nanoparticles are dropped on the surface of the rotating substrate 71. The rotation speed of the substrate 71 is again increased to 1,000 rpm after the drop of the liquid. The rotation speed of 1,000 rpm is maintained for ten seconds. The dropped liquid thus uniformly spreads over the surface of the rotating substrate 71.

The surface of the substrate 71 is then exposed to the atmosphere of nitrogen. The nitrogen serves to evaporate the hexane from the surface of the substrate 71. A continuous film of the nanoparticles 75 is in this manner obtained. The nanoparticles 75 automatically take a regular arrangement based on the self-organization.

The substrate 71 is then set in a sputtering apparatus. A PtPd target is set in the sputtering apparatus. A PtPd alloy film serving as the basement polycrystalline layer 77 is thus formed in the sputtering apparatus. The individual crystalline grains grow from the nanoparticles 75 as seed cores in the basement crystalline layer 77. The thickness of the basement polycrystalline layer 77 may be set at 5 nm approximately, for example.

A CoCrPt target is subsequently set in the sputtering apparatus. The magnetic polycrystalline layer 78 is formed on the basement polycrystalline layer 77. The crystalline grains in the magnetic polycrystalline layer 78 grow from the individual crystalline grains in the basement polycrystalline layer 77 based on the epitaxy. The thickness of the magnetic polycrystalline layer 78 may be set at 15 nm approximately, for example.

Next, a brief description will be made on a method of forming the nanoparticles 75. A flask is prepared in the atmosphere of argon gas, for example. The flask previously includes bis acetylacetonate platinum in the amount of 197 mg, corresponding to 0.5[mM], and 1,2-hexadecanediol in the amount of 390 mg. Dioctylether in the amount of 20 ml is then added into the flask. Oleic acid in the amount of 0.32 ml, corresponding to 1.0[mM], and oleylamine in the amount of 0.34 ml, corresponding to 1.0[mM], are thereafter added into the flask. Iron carbonyl, Fe(CO)5, in the amount of 0.13 ml, corresponding to 1.0[mM], is subsequently added into the flask. A solution obtained in the flask is stirred at the temperature of 230 degrees Celsius. Chemical reaction is caused in the solution. FePt nanoparticles are thus generated. The obtained nanoparticles are wrapped with an organic stabilizer such as the oleic acid and the oleylamine.

The solution in the flask is thereafter cooled to the room temperature. Ethanol in the amount of 40 ml is then added to the solution in the flask. Centrifugation is utilized to separate the deposit of the nanoparticles and organic stabilizer. The separated nanoparticles and organic stabilizer are then added to hexane. The nanoparticles disperse in the hexane. FePt nanoparticles having the average diameter of 4.3 nm can be obtained in the aforementioned manner.

FIG. 13 illustrates a vertical sectional view of the magnetic recording disk 13c according to a modification of the third embodiment. The magnetic recording disk 13c belongs to a so-called perpendicular magnetic recording medium. The magnetic recording disk 13c includes a substrate 91 as a support member and polycrystalline structure films 92 extending on the front and back surfaces of the substrate 91. The polycrystalline structure film 92 includes a soft magnetic underlayer 95 extending on the surface of the substrate 91. The underlayer 95 may be made of a soft magnetic material such as FeTaC, NiFe, or the like. Here, a FeTaC film having the thickness of 200 nm approximately is employed as the underlayer 95. The underlayer 95 allows establishment of the axis of easy magnetization within a plane parallel to the surface of the substrate 91.

The polycrystalline structure film 92 includes minute particles or nanoparticles 96 existing on the surface of the underlayer 95 serving as a substratum. The nanoparticles 96 form a continuous non-magnetic layer or extending on the surface of the underlayer 95 without a gap. The thickness of the continuous non-magnetic layer may be set at 20 nm approximately, for example. The diameter of the nanoparticles 96 may be set in a range between 2 nm and 10 nm. The diameter dispersion σ/D may be set equal to or smaller than 20% for the nanoparticles 96.

A magnetic polycrystalline layer 97 extends on the surface of the continuous layer of the nanoparticles 96. The magnetic polycrystalline layer 97 includes crystalline grains growing from the nanoparticles 96. Magnetic information is recorded in the polycrystalline structure film 72. The magnetic polycrystalline layer 97 may be made of an alloy including at least any one of the Co, Ni and Fe, for example. Here, a CoCrPt film having the thickness equal to 15 nm approximately is employed as the magnetic polycrystalline layer 97. The magnetic polycrystalline layer 97 allows establishment of the axis of easy magnetization aligned in the vertical direction perpendicular to the surface of the substrate 91.

As is apparent from FIG. 13, a controlling layer 98 may be interposed between the substrate 91 and the underlayer 95. A Cr film or an alloy film containing Cr may be employed as the controlling layer 98, for example. The controlling layer 98 serves to align the orientation of the crystalline grains in the magnetic polycrystalline layer 98.

The polycrystalline structure film 92 allows the growth of the crystalline grains in the magnetic polycrystalline layer 97 based on the nanoparticles 96. Since the size and dispersion of the nanoparticles 96 can sufficiently be controlled, the size and distribution of the crystalline grains can reliably controlled in the magnetic polycrystalline layer 97.

Next, a detailed description will be made on a method of making the magnetic recording disk 13c. The disk-shaped substrate 91 is first prepared. The controlling layer 98 and the underlayer 96 may previously be formed on the substrate 91. Sputtering may be utilized to form the controlling layer 98 and the underlayer 96, for example.

The nanoparticles 96 are then applied to the surface of the underlayer 96 based on spin coating. A continuous layer of the nanoparticles 96 is thus formed. The nanoparticles 96 are regularly ordered based on the self-organization.

The substrate 91 is then set in a sputtering apparatus. A CoCrPt target is set in the sputtering apparatus. A CoCrPt alloy film serving as the magnetic polycrystalline layer 97 is thus formed. The individual crystalline grains in the magnetic polycrystalline layer 97 grow from the nanoparticles 96. The thickness of the magnetic polycrystalline layer 97 may be set at 15 nm approximately, for example.

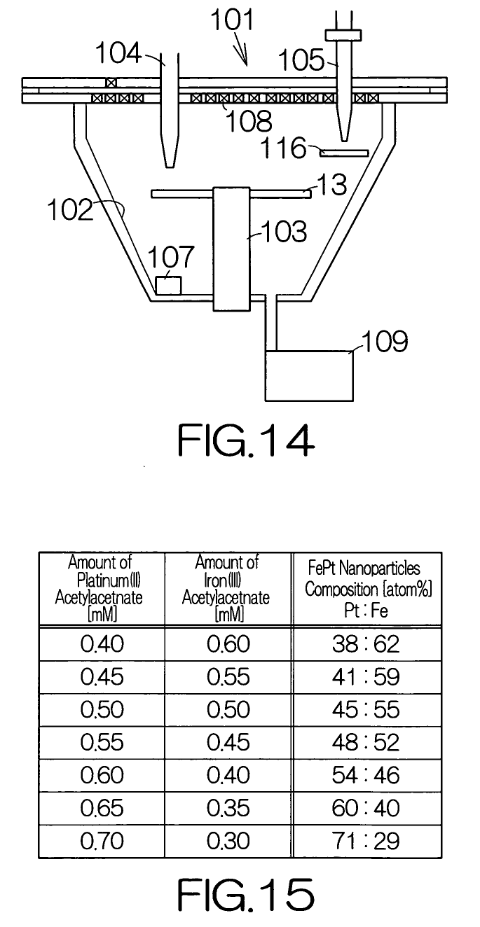

In any of the embodiments, a spin coater can be utilized to realize spin coating. FIG. 14 schematically illustrates the structure of a spin coater. The spin coater 101 includes a closed chamber 102. A rotation shaft 103 is mounted in the chamber 102. The rotation shaft 103 is designed to receive the magnetic recording disk 13, 13a, 13b, 13c. The rotation of the rotation shaft 103 causes the magnetic recording disk 13 to rotate around a predetermined rotation axis.

First and second nozzles 104, 105 protrude into the space inside the chamber 102. The tip end of the first nozzle 104 is opposed to the surface of the magnetic recording disk 13 mounted on the rotation shaft 103. The first nozzle 104 is allowed to move in the horizontal direction along a vertical plane including the longitudinal axis of the rotation shaft 103. Specifically, the first nozzle 104 moves in the radial direction of the magnetic recording disk set on the rotation shaft 103. Liquid is supplied to the first nozzle 104 from a predetermined reservoir, for example. The liquid is dropped along a swirly pattern on the surface of the magnetic recording disk 13 based on the combination of the rotation of the rotation shaft 103 and the horizontal movement of the first nozzle 104. The liquid including the organic solvent containing the nanoparticles may be supplied to the first nozzle 104.

The tip end of the second nozzle 105 is opposed to a vaporizer 106. The liquid dropped form the second nozzle 105 is received on the vaporizer 106. The vaporizer 106 generates a gas based on the evaporation of the liquid. The chamber 102 can be filled with the generated gas. A vapor pressure sensor 107 is designed to detect the vapor pressure of the gas within the chamber 102. The amount of the liquid dropped from the second nozzle 105 can be adjusted based on the detected vapor pressure. The second nozzle 105 serves to establish the atmosphere of hexane within the chamber 102.

A gas inlet 108 is formed in the chamber 102. The gas inlet 108 is opposed to the surface of the magnetic recording disk 13c mounted on the rotation shaft 103. The gas inlet 108 serves to discharge nitrogen gas toward the surface of the magnetic recording disk 13 in the aforementioned manner. A drain 109 is connected to the chamber 102. Excessive liquid can be discharged out of the chamber 102 through the drain 109.

The following method may be employed to form the nanoparticles 43, 61, 75, 96. Non-volatile metallic compound is first prepared to form the nanoparticles. Acetylacetonate salt may be employed as the metallic compound, for example. Alternatively, the metallic compound may be a salt of organic acid selected from a group consisting of a salt of carboxylic acid, a salt of hydrocyanic acid, a salt of sulfonic acid, and a salt of phosphonic acid. The organic acid should have the carbon number in a range between 1 and 20. Otherwise, bromide and iodide may be employed as the metallic compound. The metallic compound may include atoms belonging to element selected from Fe, Co, Ni, Pt, Cr, Cu, Ag, Mn and Pb. Two or more kinds of the metallic compound may be employed in forming the nanoparticles.

An organic solvent is prepared in forming the nanoparticles. An aprotic organic solvent such as hydrocarbon, ether, ester, or the like, may be employed as the organic solvent, for example. The organic solvent should have the carbon number ranging from 2 to 20. The ether includes dioctylether.

A reducing agent refractory to the aprotic organic solvent is prepared in forming the nanoparticles. 1,2-diol may be employed as the reducing agent, for example. The 1,2-diol should have the carbon number ranging from 2 to 6 in this case. The 1,2-diol includes a 1,2-butanediol, for example.

A predetermined organic stabilizer is prepared in forming the nanoparticles. The organic stabilizer includes carboxylic acid, R-COOH, for example. In this case, “R” may be selected from a straight chain hydrocarbon group including a double bond. The straight chain hydrocarbon group may be selected from a group consisting of C₁₂H₂₃, C₁₇H₃₃ and C₂₁H₄₁. Otherwise, the organic stabilizer may include amine, R-NH₂, for example. “R” may likewise be selected from a straight chain hydrocarbon group including a double bond. The straight chain hydrocarbon group may be selected from a group consisting of C₁₃H₂₅, C₁₆H₃₅ and C₂₂H₄₃. The organic solvent may include one or both of the carboxylic acid and amine.

A flask is prepared in the atmosphere of inert gas such as nitrogen and argon, for example. A solution is prepared in the flask based on the mixture of the aforementioned metallic compound, organic solvent, reducing agent and organic stabilizer. The solution is stirred in the flask at a predetermined reaction temperature. The temperature may be set in a range between 100 degrees Celsius and 300 degrees Celsius, for example. The metal is reduced from the metallic compound with the assistance of the reducing agent in the solution. The nanoparticles can in this manner be obtained. The individual nanoparticle is wrapped with the organic stabilizer such as oleic acid and oleylamine.

The solution in the flask is then cooled down to the room temperature. The solvent such as ethanol is added into the flask. Centrifugation is utilized to separate the deposit of the nanoparticles and the organic stabilizer. The nanoparticles and the organic stabilizer are then added into an organic solvent such as hexane. One can in this manner obtain the hexane solution containing the nanoparticles dispersed therein.

The method enables isolation of the reducing agent and the organic solvent from each other since the 1,2-diol is refractory to the aprotic organic solvent such as hydrocarbon, ether, ester, or the like. The polarity of the solution can be kept lower, so that the nanoparticles are reliably prevented from accretion. The fine and uniform nanoparticles can thus be obtained in a facilitated manner.

The inventors have made FePt nanoparticles based on the aforementioned method. A flask was prepared in the atmosphere of argon gas. The metallic compounds, platinum(II) acetylacetonate in the amount of 197 mg, corresponding to 0.5[mM], and iron(III) acetylacetonate in the amount of 177 mg, corresponding to 0.5[mM], were placed in the flask. The organic solvent, dioctylether, in the amount of 10 ml was subsequently added into the flask. The reducing agent, 1,2-butanediol in the amount of 0.91 ml was subsequently added into the flask. The organic stabilizer, oleic acid in the amount of 0.16 ml, corresponding to 0.05[mM], and oleylamine in the amount of 0.17 m, corresponding to 0.5[mM], were subsequently added into the flask.

The solution in the flask was then subjected to agitation at the temperature of 190 degrees Celsius for thirty minutes. The solution in the flask was then cooled down to the room temperature. Ethanol in the amount of 10 ml was then added into the flask. The deposit of the nanoparticles and the organic stabilizer was taken out of the solution based on centrifugation. The nanoparticles and the organic stabilizer were then added into a hexane solution. The inventors thus obtained FePt nanoparticles dispersed in the hexane solution in this manner.

The inventors have observed the obtained FePt nanoparticles. The inventors have confirmed that the FePt nanoparticles have the average diameter of 2.9 nm. The fine and uniform nanoparticles have been obtained. The ratio between Fe and Pt was Fe:Pt=45:55[%] in the FePt nanoparticles.

The inventor have observed the relationship between the amount of metallic compound and the composition of the nanoparticles. Platinum(II) acetylacetonate and iron(III) acetylacetonate were utilized to form the nanoparticles in the aforementioned manner. The inventors varied the amount of the metallic compounds. As shown in FIG. 15, it has been confirmed that the composition of the FePt nanoparticles reflects the ratio of the amounts of platinum(II) acetylacetonate and iron(III) acetylacetonate. In other words, the adjustment on the amount of the metallic compound or compounds can be utilized to control the composition of nanoparticles.

The inventors have demonstrated that the aforementioned platinum(II) acetylacetonate can be replaced with platinum(II) acetate, platinum(II) benzoic acid, platinum(II) cyanide, platinum(II) benzenesulfonic acid, platinum(II) propylphosphonic acid, platinum(II) bromide, platinum(II) iodide, or the like. The inventors have also demonstrated that the aforementioned iron(III) acetylacetonate can be replaced with iron(III) acetate, iron(III) benzoic acid, iron(III) cyanide, iron( III) benzenesulfonic acid, iron( III) propylphosphonic acid, iron(III) bromide, iron(III) iodide, iron(II) acetylacetonate, iron(II) acetate, iron(II) benzoic acid, iron(II) cyanide, iron(II) benzenesulfonicacid, iron(II) propylphosphonic acid, iron(II) bromide, or the like. Moreover, the inventors have demonstrated that 1,2-butanediol can be replaced with 1,2-diol having a carbon number selected from a group consisting of 2, 3, 5 and 6.

Furthermore, the inventors have made nanoparticles based on platinum(II) acetylacetonate, iron(III) acetylacetonate and bis acetylacetonate copper(II) in accordance with the aforementioned method. PtFeCu nanoparticles having the average diameter ranging from 2.7 mn to 3.5 nm were obtained. The inventors have demonstrated that the composition of the PtFeCu nanoparticles reflects the amount of the metallic compound or compounds.

The inventors have made nanoparticles based on platinum(II) acetylacetonate, iron(III) acetylacetonate and silver(I) acetate in accordance with aforementioned method. PtFeAg nanoparticles having the average diameter ranging from 2.6 mn to 3.4 nm were obtained. The inventors have demonstrated that the composition of the PtFeAg nanoparticles reflects the amount of the metallic compound or compounds.

Furthermore, the inventors have made nanoparticles based the aforementioned method. Any one of cobalt(I) acetylacetonate, chrome(III) acetylacetonate, nickel(II) acetylacetonate, manganese(II) acetylacetonate, and lead(II) acetylacetonate were used in addition to the aforementioned platinum(II) acetylacetonate and iron(III) acetylacetonate. PtFeCo nanoparticles, PtFeCr nanoparticles, PtFeNi nanoparticles, PtFeMn nanoparticles, PtFePb nanoparticles, having the average diameter ranging from 2.6 mn to 3.6 nm were obtained. The inventors have demonstrated that the composition of these nanoparticles reflects the amount of the metallic compound or compounds.

1. A composite material comprising:
a substrate defining minute holes over its surface; and
particles located within the minute holes.

2. The composite material according to claim 1, further comprising a covering layer overlaid on the surface of the substrate so as to entrap the particles inside the minute holes.

3. The composite material according to claim 1, wherein one of the substrate and the particles is made of a magnetic material while other of the substrate and the particles is made of a non-magnetic material.

4. The composite material according to claim 1, wherein one of the substrate and the particles is made of an electrically conductive material while other of the substrate and the particles is made of an insulating material.

5. A method of making a composite material, comprising:
preparing a substrate defining minute holes over its surface;
applying to the surface of the substrate liquid including a predetermined solvent containing particles; and
wiping overspilling ones of the particles, said overspilling ones spilling out of the minute holes.

6. The method according to claim 5, wherein spin coating or dipping is effected to apply the liquid.

7. The method according to claim 5, wherein one of the substrate and the particles is made of a magnetic material while other of the substrate and the particles is made of a non-magnetic material.

8. A structure comprising:
an aggregation of particles; and
carbon atoms existing between the particles, wherein
atomicity of the carbon atoms is set in a range between 45 atom % and 96 atom % to sum of atomicity of the carbon atoms and atomicity of atoms forming the particles.

9. The structure according to claim 8, wherein diameter of the particles is set in a range between 1 nm and 30 nm.

10. The structure according to claim 8, wherein said particles include a crystalline grain.

11. A method of making a structure, comprising:
applying to a surface of an object an organic solvent containing metallic particles wrapped with an organic compound; and
annealing the metallic particles under a vacuum atmosphere after evaporation of the organic solvent, wherein
atomicity of the carbon atoms included in the organic compound is set in a range between 45 atom % and 96 atom % to sum of atomicity of the carbon atoms and atomicity of atoms forming the metallic particles.

12. The method according to claim 11, further comprising subjecting the organic compound to heating treatment under atmosphere of inert gas prior to annealing.

13. A polycrystalline structure film comprising:
a substratum;
particles located on a surface of the substratum; and
a crystalline layer including crystalline grains growing from the particles.

14. The polycrystalline structure film according to claim 13, wherein said particles contain atoms belonging to a metallic element.

15. The polycrystalline structure film according to claim 13, wherein said particles form a continuous layer extending on the surface of the substratum.

16. A method of making particles, comprising:
preparing a solution including an organic solvent containing a reducing agent refractory to the organic solvent, a metallic compound and an organic stabilizer; and
stirring the solution at a predetermined reaction temperature.

17. The method according to claim 16, wherein said solution includes two or more kinds of the metallic compound.

18. The method according claim 16, wherein said organic solvent is an aprotic organic solvent having a carbon number in a range between 6 and 20.

19. The method according to claim 16, wherein said organic stabilizer includes an amine.
